(19) United States
(12) Patent Application Publication
(10) Pub. No.: US 2024/0107227 A1
(43) Pub. Date: Mar. 28, 2024

(54) UNDERWATER SURFACE MOUNTABLE SPEAKER

(71) Applicant: CLARK SYNTHESIS, INC., LITTLETON, CO (US)

(72) Inventor: William A. PHILLIPS, LITTLETON, CO (US)

(21) Appl. No.: 17/952,293

(22) Filed: Sep. 25, 2022

(51) Int. Cl. H04R 1/44; E04H 4/14

(52) U.S. Cl. CPC H04R 1/44; E04H 4/14

(57) ABSTRACT

An underwater surface mountable speaker includes a high-gain acoustic transducer operatively coupled to a sound radiator whereby vibrations emitted from the transducer are communicated to the sound radiator. The sound radiator includes side ports configured to direct vibrations emitted from all surfaces of the transducer laterally from the speaker. The speaker is therefore front-firing and side-firing. Additionally, the speaker includes a base that is adapted for mounting to a plurality of standard structures and surfaces seen in the art, including to a directional flow outlet or inlet return fitting, a light niche, or directly to a swimming pool wall or other underwater surface.

### BACKGROUND OF THE INVENTION

Sound is perceived when compressive waves moving through the atmosphere biomechanically stimulate receptors in the brain. Generally, to create sound from electrical signals, speaker cones move forwards and backwards to compress and rarify immediately adjacent atmosphere and create a pulse of compressive waves that biomechanically stimulate receptors in the ear to create the perception of sound.

Passing sound through water, however, is more difficult. The density of air is relatively low, at approximately 1.204 kg/m³ at 68° F. This is approximately 1/800^{th} the density of water (1,000 kg/m³). The higher density of water makes use of compressive waves for creating underwater sound impractical.

Underwater speakers, therefore, do not typically rely on compressive forces created by the mechanical action of cones or equivalent structures. Underwater speakers instead create vibrations across a surface that emits soundwaves through the water as sinusoidal vibrations. This is similar to the means by which sound is produced off the surface of a stringed instrument, like a cello, for example.

Underwater speakers are known in the art, however underwater speakers seen in the art present significant limitations. Most only allow for front-firing when installed in a light niche; that is, for vibrations emitted anteriorly from a surface. Further, convenient attachment or mounting to a plurality of underwater surfaces is not typically practiced in the art: most underwater speakers seen in the art require installation or retrofitting light niches and require specialty installation at the time a swimming pool or other aquatic environment is constructed. See, e.g., underwater speakers by Lubell Labs®, Oceaners®, and Electro-Voice®. Some are simply suspended into a water body. See, e.g., Oceaners® and Electro-Voice®. There is a need for a more efficient underwater speaker, one that sets forth better sound penetration through water and one that is mountable to standard, existing structures in swimming pools and other aquatic environments whereby installation into existing swimming pools and other aquatic environments is facilitated via a number of mounting options as well as by specialty installation at the time of construction of the swimming pool or aquatic environment.

The present invention, therefore, contemplates an underwater surface mountable speaker that enables greater penetration of sound vibrations throughout a watery medium is by side-firing in addition to front-firing as well as enabling mounting of the underwater speaker to underwater surfaces and fixtures that are common to existing swimming pools in a cost effective and efficient manner.

Thus, the present invention relates to an underwater surface mountable speaker that may be retrofitted into existing swimming pools, installed into new swimming pools, or used in other submerged or aquatic environments with a greater potential for sound penetration throughout the water body.

### FIELD OF THE INVENTION

The present invention relates to an underwater surface mountable speaker, and more particularly, to an underwater surface mountable speaker that is mountable to a plurality of underwater surfaces and fixtures commonly used in swimming pools and other aquatic environments. The present invention further relates to an underwater surface mountable speaker that enables side-firing of sound vibrations, in addition to front-firing, by action of a high-gain acoustic transducer operatively communicating with a sound radiator that also serves as a sound lens.

### SUMMARY OF THE INVENTION

As used herein throughout, the term “directional flow outlet” is taken to mean the conduits through which water is recirculated to a swimming pool or aquatic body. In swimming pools and other manmade or closed aquatic environments, water is typically filtered through a filtration or treatment system. The filtration or treatment system may take water from the water body through traps, grates, drains, or other apertures and conveyances, whereby water is removed from the main water body for treatment. Water is then returned to the water body through return lines. These are typically conduits, piping, and/or plumbing through which water is forced back into the water body, often from more than one location to create a circulation within the water body. Such directional flow outlets (or, in some countries and usages, directional flow “inlets”) effectively force water back into the water body after filtration and/or treatment and create circulation and waterflow within the water body. Directional flow outlets, therefore, present known strictures and standardized fittings pervasive in the art to which the present invention may be particularly adapted in some embodiments.

Underwater speakers are seen in the art. Most set forth front-firing speakers with limited mounting options. For example, most are engineered only for incorporation to existing light niches or to be directly submerged or suspended in water. Wall mounts, mounts to directional flow outlets, or other means of mounting underwater speakers to standard, existing structures, or directly to a poolside, are typically unknown and are not readily practiced in the art. Underwater speakers seen in the art typically require specialty installation at time of construction, or specialty installation into existing pools which is, in many cases, cost prohibitive.

The present invention, therefore, enables mounting underwater speakers directly to an underwater surface (such as a pool wall), upon or suspended from a directional flow outlet, or within or upon an existing light niche in multiple ways. The present invention enables installation of an underwater speaker into an existing pool using existing and standard fittings or, alternatively, enables custom fit to a pool when the pool is constructed to present a cost-effective means of installation.

Further, the present invention situates a high-gain acoustic transducer interior to a novel sound radiator that serves as sound-lens and enables transmission of sonic vibrations from the sides of the speaker as well as from the front. The present invention, therefore, contemplates front- and side-firing sonic vibrations into the surrounding water for more efficient penetration of sound into surrounding water and a greater range of enjoyment by users swimming therein.

Additionally, the present invention contemplates lighting elements coupled to the speaker whereby the speaker may also serve as a light source. The instant underwater surface mountable speaker also incorporates a bonding connector, to connect the speaker to a pool's equipotential bonding circuit to ground stray electrical currents. Additionally, the instant underwater surface mountable speaker may incorporate a sacrificial anode to prevent mineralization around the speaker in use, particularly in saltwater environments.

The present underwater surface mountable speaker, therefore, includes a high-gain acoustic transducer configured to turn electrical signals into sound vibrations. The high-gain acoustic transducer is operationally coupled to a sound radiator whereby vibrations from the transducer are communicated to the radiator. The sound radiator is configured to transmit sound vibrations forwards and from its sides. The sound radiator includes side ports to increase the efficiency of sound transmission into the surrounding water, whereby vibrations from all surfaces of the transducer are directed anteriorly and from the sides of the sound radiator into the surrounding water. The sound radiator thus serves as a sound lens to direct vibrations from the transducer into the water as well as to emit vibrations communicated to the sound radiator by action of the transducer. The high-gain acoustic transducer and sound radiator are operatively coupled to a base, which base enables a plurality of mounting options to underwater surfaces and structures, as will be set forth herein below.

The base provides a means to secure the transducer and sound radiator in operational communication. The base also serves as the support for a bonding plate and bonding connector, to connect the underwater surface mountable speaker to an equipotential bonding system in use with most swimming pools, and as a support for an optional sacrificial anode disposed to prevent mineralization build up in use of the speaker (particularly in saline environments). Further, the base provides for a plurality of mounting configurations, enabling the underwater surface mountable speaker to be mounted directly to the wall of a swimming pool by screws or other fasteners, for example; upon or—by means of a hanger member—suspended upon a directional flow outlet; or, by action of a clip member, mounting interior to an existing light niche in a swimming pool. Modified clips in conjunction with the base may allow for fitting to non-standard light niches seen in the art.

Additionally, the base provides for the addition of suction cup elements whereby the underwater surface mountable speaker may be mounted to a surface such as the interior of an aquarium, the poolside, or even the hull of a boat, say, among other surfaces to which suction cups may attach. The underwater surface mountable speaker is, therefore, configured for installation to a plurality of existing and standard structures seen in the swimming pool arts whereby the instant underwater surface mountable speaker is adapted for use in existing swimming pools without incurring considerable expense in installation.

Additionally, the base may accommodate at least one light source. In some embodiments wherein a light source is incorporated into the underwater surface mountable speaker, the sound radiator may be made translucent or transparent whereby the light source is configured to shine through the sound radiator or, at least, the sound radiator does not impede the light source to create unwanted shadowing. Additional embodiments are contemplated as within scope of this disclosure, including speakers having light sources mounted or coupled to the base and/or speaker in other ways upon and within the base.

Lastly, the base enables enclosure for additional cable for use when the high-gain transducer requires maintenance.

In use, when directly attached to the pool wall, the underwater surface mountable speaker is powered by connection with an existing circuit by means of a power cable disposed through a hole drilled through the pool wall, or otherwise routed via impervious channel or conduit to connect with an existing circuit. Additionally, the underwater surface mountable speaker may be installed to a non-functional directional flow outlet, or a non-functional directional flow outlet installed specifically for the purpose of mounting the speaker. This enables use of existing, standard materials commonly employed in swimming pools. In such an installation, an inactive return line may be installed into the pool and conduit terminated at a junction box above the water surface. The speaker cables may thence be routed through the base and through the return line conduit to connect to the junction box. Output from the amplifier is then connected to the speaker cable at the junction box and the cable for powering the light source (when included) is attached to the light controller's output. Such a configuration enables use of existing structures common to swimming pools and already mass produced for installation therein, enabling a cost-effective option for safe and permanent installation.

Additionally, the underwater surface mountable speaker may be installed to an active directional flow outlet by means of a hanger member. The hander member is configured to position the speaker suspended from, or in conjunction with, the directional flow outlet whereby the speaker is maintained a certain depth below or in conjunction with the directional flow outlet. The speaker cables can be routed through the return line, through existing piping, and taken from the active return through at least one T-fitting with a cable gland. Additional means of connecting the underwater surface mountable speaker in circuit with an amplifier and power source are contemplated as within scope of this disclosure, as set forth herein below.

Where the underwater surface mountable speaker is installed to a light niche in the swimming pool, the speaker cables are routed to the surface through the conduit connected to service the niche. Further, for ease of installation, and where the speaker may be used suctioned to a surface, the speaker cables can be readily routed up the pool wall or via an extremal conduit to an appropriately positioned junction box.

Thus, has been broadly outlined the more important features of the present underwater surface mountable speaker so that the detailed description thereof that follows may be better understood and in order that the present contribution to the art may be better appreciated.

Objects of the present underwater surface mountable speaker, along with various novel features that characterize the invention are particularly pointed out in the claims forming a part of this disclosure. For better understanding of the underwater surface mountable speaker, its operating advantages and specific objects attained by its uses, refer to the accompanying drawings and description.

### BRIEF DESCRIPTION OF THE DRAWINGS

### Figures

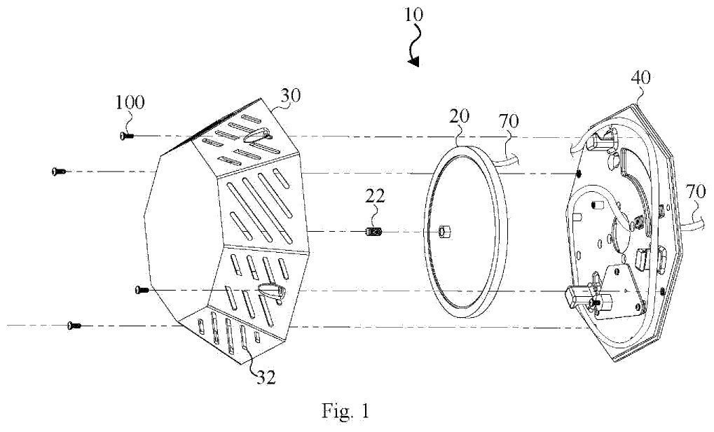

FIG. 1 is an elevation, exploded view of an example embodiment of an underwater surface mountable speaker.

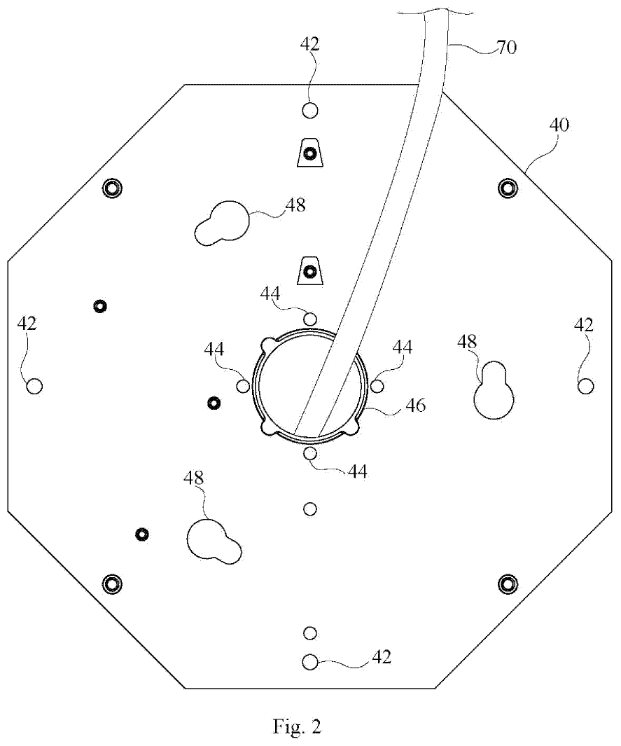

FIG. 2 is a rear elevation view of an example embodiment of the base of the underwater surface mountable speaker illustrating a plurality of attachment options for installation of the speaker in a plurality of ways.

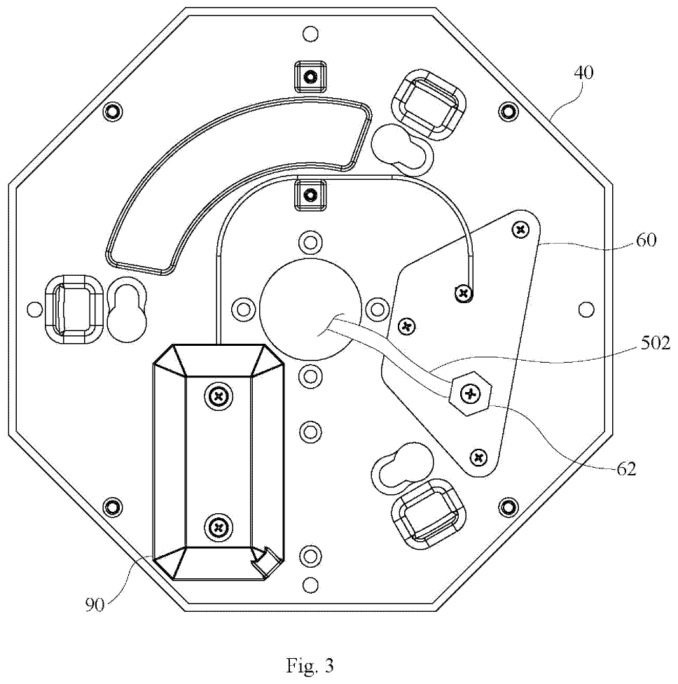

FIG. 3 is a top elevation view of an example embodiment of the base of the underwater surface mountable speaker illustrating means for bonding the speaker to an existing bonding circuit and, for use with saltwater bodies, an optional sacrificial anode.

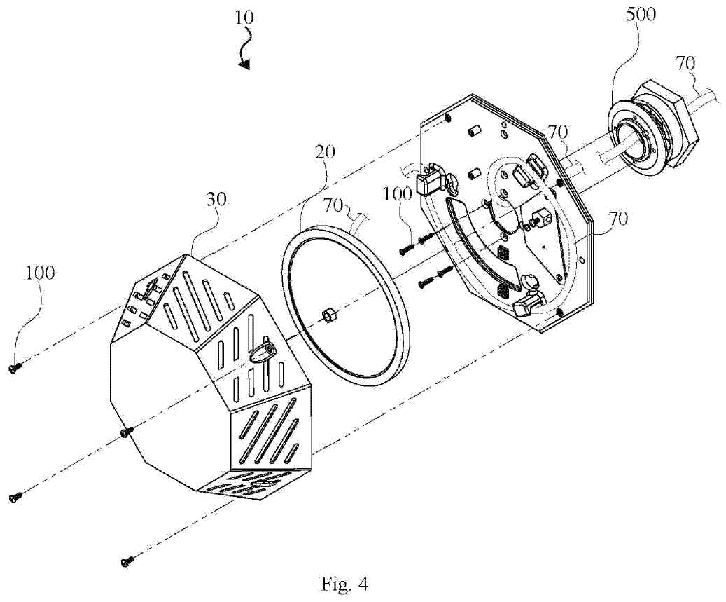

FIG. 4 is an elevation exploded view of an example embodiment of the underwater surface mountable speaker configured for installation to a directional flow outlet.

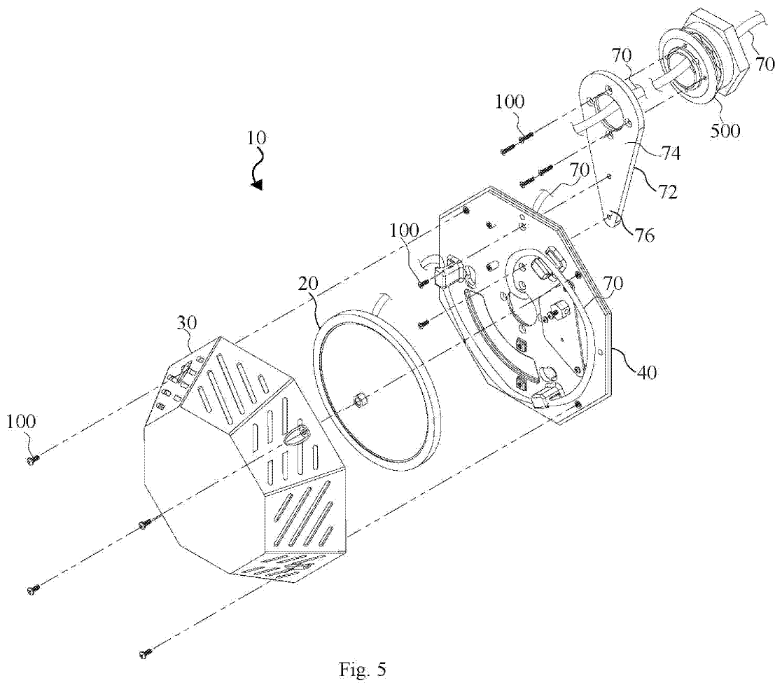

FIG. 5 is an elevation exploded view of an example embodiment of the underwater surface mountable speaker configured for installation to an active directional flow outlet by means of a hanger member.

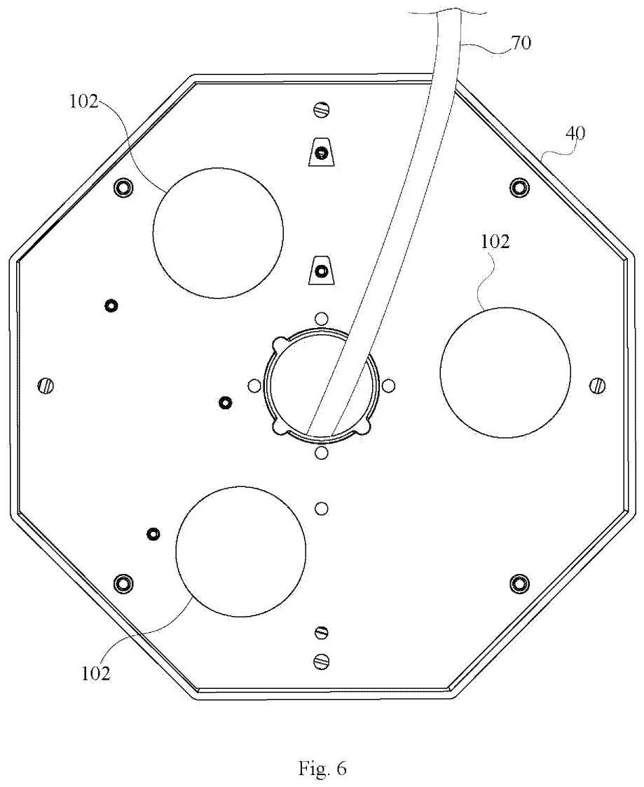

FIG. 6 is a rear elevation view of an example embodiment of the underwater surface mountable speaker having suction cup elements installed to a plurality of suction cup mounts.

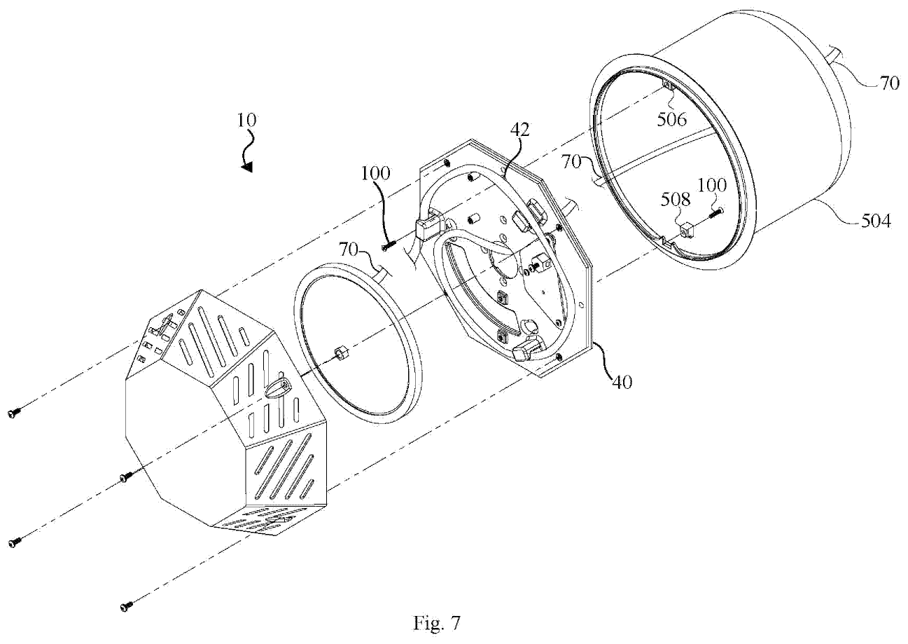

FIG. 7 is a diagonal elevation exploded view of the underwater surface mountable speaker configured for installation into an existing light niche in a swimming pool.

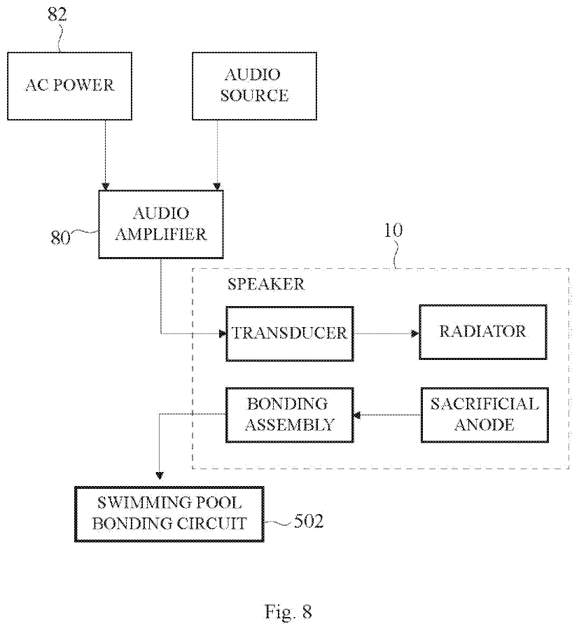

FIG. 8 is a diagrammatic view of the underwater surface mountable speaker in circuit with an amplifier, power source, and bonding circuit.

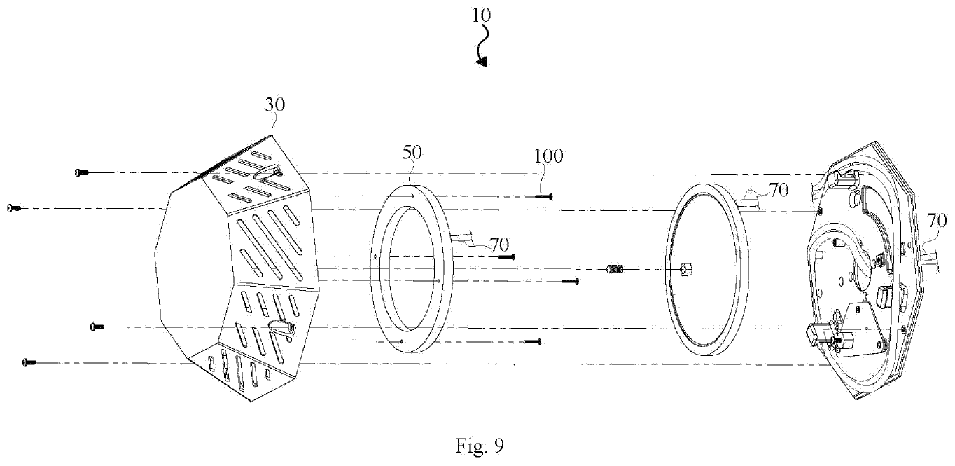

FIG. 9 is a diagonal elevation exploded view of the underwater surface mountable speaker including a light source in the form of a ring Light Emitting Diode.

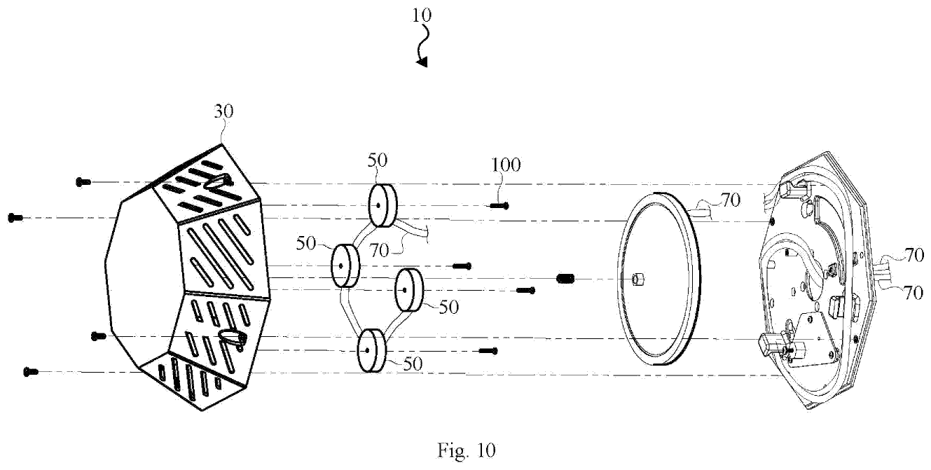

FIG. 10 is a diagonal elevation exploded view of the underwater surface mountable speaker including an alternative light source configuration.

### DETAILED DESCRIPTION OF THE DRAWINGS

With reference now to the drawings, and in particular FIGS. 1 through 10 thereof, example of the instant underwater surface mountable speaker employing the principles and concepts of the present underwater surface mountable speaker and generally designated by the reference number 10 will be described.

In an example embodiment set forth herein, the present underwater surface mountable speaker has a frequency response of 20 Hz to 17.5 kHz. The example embodiment set forth herein is rated at 135 watts continuous at 4 ohms. The speaker includes underwater cable attached and ready for connection at a junction box with, or directly to, an amplifier.

FIG. 1 shows an example embodiment of underwater surface mountable speaker 10 in exploded view. High-gain acoustic transducer 20 is operatively coupled to sound radiator 30 by means of connecting rod 22. In the example embodiment shown, connecting rod 22 is threadably engaged to sound radiator 30. Vibrations produced from electrical signals by the high-gain acoustic transducer 20 are mechanically communicated to sound radiator 30 by means of connecting rod 22. Sound radiator 30 includes side ports 32 to direct vibrations emitted directly from transducer 20 laterally into the surrounding water. Thus, vibrations emitted from the surfaces of transducer 20 are communicated into the surrounding water through side ports 32 of sound radiator 30. Sound radiator 30 therefore functions additionally as a sound-lens as well as a source of vibrations itself. Underwater surface mountable speaker 10, therefore, fires from all sides of sound radiator 30 as well as anteriorly therefrom.

Base 40 is configured to secure transducer 20 and sound radiator 30 in position and provides for a plurality of mounting options by which underwater surface mountable speaker 10 may be installed to an underwater surface in a swimming pool or other aquatic environment.

FIG. 2 illustrates a rear elevation view of an example embodiment of base 40. Base 40 includes a plurality of mounting holes 42 disposed perimetrically or circumferentially proximal outer rim of base 40. Plurality of mounting holes 42 enables direct fastening of base 40 to a pool wall or other aquatic surface. Fasteners 100 engage through mounting holes 42 to directly secure base 40 in contact with the surface (as shown, for example, in FIG. 1). Base 40 further includes a plurality of inner holes 44 circumferentially disposed around central aperture 46. Plurality of inner holes 44 is sized and spaced appropriately to enable direct securement of base to a directional flow outlet 500. Fasteners 100 engage through inner holes 44 to directly secure base 40 in contact with the directional flow outlet 500 (as shown, for example, in FIG. 4). Further, a plurality of suction cup mounts 48 is disposed upon base 40. Suction cup mounts 48 enable attachment of suction cup elements 102 by which base 40 may be suctioned to an underwater surface (as shown, for example, in FIG. 6). In this example embodiment, speaker cables 70 (including power cables for light source 50, when present) are run through central aperture 46 to connect with amplifier 80 and power source 82 remotely disposed relative to the water body. Bonding connection to bonding assembly 60 may likewise be effectuated alongside cables, as is described below.

FIG. 3 illustrates a top elevation view of an example embodiment of base 40. In this example embodiment, bonding assembly 60 is included to enable connection of underwater surface mountable speaker 10 to an existing bonding circuit 502. Bonding is perfected by connection of bonding connector 62 to the bonding circuit 502. Bonding may be accommodated alongside cables 70. Additionally, FIG. 3 illustrates an example embodiment of base 40 having sacrificial anode 90 installed. Sacrificial anode 90 is optional; however, particularly in saltwater environments, sacrificial anode 90 may be preferably incorporated to underwater surface mountable speaker 10 to prevent mineralization in-use of speaker 10 and the resulting unaesthetic discoloration that can appear upon surfaces proximal to speaker 10. Sacrificial anode 90, therefore, incorporates a base metal (typically zinc or aluminum, for example) to prevent precipitation of minerals proximal to speaker 10.

FIG. 4 illustrates a elevation exploded view of an example embodiment of base 40 disposed for installation to an existing directional flow outlet 500 as seen in the swimming pool arts. In this example embodiment, base 40 is installed directly to outlet 500. Fasteners 100 engage through inner holes 44 to directly attach base 40 to outlet 500. Cables 70 are routable through outlet 500 and existing piping to connect with power source 82 and amplifier 80 at a location removed from the water surface. In such an embodiment, directional flow outlet 500 may preferably be inactive and not produce return waterflow into the swimming pool.

FIG. 5 illustrates an example embodiment of base 40 disposed for installation to an existing directional flow outlet 500 by means of hanger member 72 whereby underwater surface mountable speaker 10 is positional removed from waterflow produced at directional flow outlet 500. Hanger member 72 therefore enables mounting of underwater surface mountable speaker 10 to an operational directional flow outlet 500 without interfering with waterflow produced at outlet 500. In the example embodiment shown, hanger member 72 includes upper portion 74 and lower portion 76. Upper portion is configured to secure to an active directional flow outlet 500 existing and functional in a swimming pool wall; in this example embodiment, by means of fasteners 100 disposed to engage through upper portion 74 to outlet 500. Base 40 then connects to lower portion 76 of hanger member 72. Underwater surface mountable speaker 10 is therefore suspended from directional flow outlet 500 and maintained securely submerged in contact with the swimming pool wall.

In this example embodiment, speaker cables 70 may be routed through the directional flow outlet 500, existing piping, in other conduit, or routed directly up the swimming pool wall, as preferred.

FIG. 6 illustrates an example embodiment of base 40 configured for suctioned engagement to an underwater surface. Suction cup elements 102 are attached to base 40 by means of suction cup mounts 48 disposed on base 40 to rearwardly position suction cup elements 102 for engagement against a desired surface (see, e.g., FIG. 1). Suction cup elements 102 enable self-supporting attachment of underwater surface mountable speaker 10 to an underwater surface. In this example embodiment, speaker cables 70 may be routed up the swimming pool wall to connect in circuit to a remotely situated amplifier and power source or in any of the manners previously and latterly described.

FIG. 7 illustrates an example embodiment of underwater surface mountable speaker 10 configured for installation in or to an existing light niche 504. Base 40 is sized appropriate to present one of the plurality of mounting holes 42 for engagement with threaded aperture 506 disposed on niche 504 casing. Niche mount tab 508 may be employed to secure base 40 to niche 504 casing at bottom. While most light niches 504 conform to standard specifications in swimming pools seen in the art, additional tabs and/or adapters are contemplated to fit base 40 to light niches 504 that deviate from said standard specifications whereby underwater surface mountable speaker 10 is installable to a variety of light niches 504 seen in the art.

FIG. 8 is a diagrammatic view of an example embodiment of underwater surface mountable speaker 10 connected in circuit with an amplifier 80, power source 82, and existing bonding circuit 502. Means to wire underwater surface mountable speaker 10 in circuit with amplifier 80, power source 82, and bonding circuit 502 are contemplated to include any reasonable means of routing cables in safe and waterproof capacity.

FIG. 9 is an exploded view of an example embodiment of underwater surface mountable speaker 10 including a light source 50. In this example embodiment depicted, light source 50 is a ring Light Emitting Diode. Sound radiator 30 may be rendered transparent, or at least translucent, to enable transmission of light therethrough. Additional and other means of illuminating underwater surface mountable speaker 10 are contemplated as within scope of this disclosure, including, for example, apertures in, or translucent or transparent portions of, sound radiator 30 configured to enable selective transmission of light. Light source 50 may be situated exteriorly around base 40 upon base 40 or elsewhere upon or around speaker 10, and may include means to effectuate an array of colors (such as by incorporating lenses and filters into sound radiator 30 or base 40, for example). As shown in FIG. 10, additional and other light sources 50 are contemplated as within scope of this disclosure, including single or clustered light sources, for example, such as cluster Light Emitting Diodes, bulbs, or other illuminable members, whereby additional means of using the instant underwater surface mountable speaker 10 as a light source are configurable, as determinable by persons having ordinary skill in the art.

What is claimed is:

1. An underwater surface mountable speaker comprising:
an acoustic transducer;
a sound radiator operatively coupled to the transducer; and
a base member;
wherein the base member is configured for mounting to an underwater surface, a swimming pool directional flow outlet or inlet, or an existing light niche.

2. The underwater surface mountable speaker of claim 1 wherein the sound radiator is configured to deliver sound waves anteriorly and radially from a radiator surface.

3. The underwater surface mountable speaker of claim 2 wherein the sound radiator further comprises side ports wherein sound waves originating from a rear surface of the radiator are directed anteriorly and/or radially from the radiator.

4. The underwater surface mountable speaker of claim 3 wherein the sound radiator is operatively coupled to the transducer by means of a connector rod whereby vibrations produced by the transducer are communicated to the radiator by means of the connector rod.

5. The underwater surface mountable speaker of claim 4 wherein the base member further comprises a bonding connector.

6. The underwater surface mountable speaker of claim 5 wherein the base member further comprises a sacrificial anode.

7. The underwater surface mountable speaker of claim 1 further comprising at least one light.

8. The underwater surface mountable speaker of claim 7 wherein the sound radiator is translucent or transparent.

9. The underwater surface mountable speaker of claim 7 wherein the at least one light is a ring light or a plurality of lights.

10. The underwater surface mountable speaker of claim 1 wherein the base member further comprises means for connecting to a directional flow inlet or outlet while positioning the underwater surface mountable speaker clear of a waterflow.

11. An underwater surface mountable speaker comprising:
an acoustic transducer;
a sound radiator operatively coupled to the transducer by means of a connector rod wherein vibrations produced by the transducer are operatively communicated to the sound radiator through the connector rod whereby sound waves are delivered anteriorly and radially from the sound radiator;
a base member; and
at least one light;
wherein the base member is configured for mounting to an underwater surface, a swimming pool directional flow inlet or outlet, or an existing light niche.

12. The underwater surface mountable speaker of claim 11 wherein the sound radiator further comprises at least one side port wherein vibrations produced from a rear surface of the sound radiator are directed radially and anteriorly.

13. The underwater surface mountable speaker of claim 11 wherein the at least one light is a ring light or a plurality of lights.

14. The underwater surface mountable speaker of claim 13 wherein the sound radiator is translucent or transparent.

15. The underwater surface mountable speaker of claim 11 wherein the base member further comprises a bonding connector.

16. The underwater surface mountable speaker of claim 15 wherein the base member further comprises a sacrificial anode.
